(19) United States
(12) Patent Application Publication
(10) Pub. No.: US 2007/0138877 A1
(43) Pub. Date: Jun. 21, 2007

(54) Connecting device

(76) Inventors: Jochen Moench, Sinzheim (DE); Christof Bernauer, Hundsbach (DE)

Correspondence Address: Striker Striker & Stenby, 103 East Neck Road, Huntington, NY, 11743, US

(21) Appl. No.: 10/587,418

(22) PCT Filed: Aug. 12, 2005
(86) PCT No.: PCT/EP05/53988

§ 371 Date: Jul. 27, 2006

(30) Foreign Application Priority Data
Sep. 30, 2004 (DE) 10 2004 047 471.0

(51) Int. Cl. H02K 5/24; F16M 9/00; H02K 7/10; H02K 5/00

(52) U.S. Cl. 310/51; 248/638; 310/91; 310/83

(57) ABSTRACT

A connecting device (1) is used to mechanically connect a motor housing (2) of a motor (5) to a transmission housing (3) of a transmission (7). The motor (5) acts on the transmission (7) via a motor shaft (6). The connecting device (1) has a connecting element (15, 26), which can connect the motor housing (2) indirectly to the transmission housing (3). The connecting element (15, 26) is embodied so that when the motor housing (2) moves relative to the transmission housing (3) in a rotating fashion around an axis (25) predetermined by the motor shaft (6), the connecting element (15, 26) can be at least partially deformed.

### PRIOR ART

The present invention relates to a connecting device for mechanically connecting a motor housing of a motor to a transmission housing of a transmission, in particular, a connecting device for connecting a motor housing of an electric motor to a transmission housing of a transmission in order to form an auxiliary drive unit for motor vehicles.

DE 197 20 254 A1 has disclosed an electromotive drive unit in which the motor housing of a motor is connected to the transmission housing of a transmission in which the motor acts on the transmission via a motor shaft. In order to prevent unpleasant noise of the electromotive drive unit from being transmitted to the housing to which it is connected, DE 197 20 254 A1 has disclosed a coupling device that connects the electromotive drive unit to another housing part. To this end, the known coupling device has a connecting element, which, by means of play or a small contact surface, generates a jump in the acoustic impedances in the acoustic duct and thus a powerful damping of the transmitted sound. The contact surface can be in the form of a point or a line.

In the coupling device disclosed in DE 197 20 254 A1, the vibration decoupling occurs at the interface between the electromotive drive unit, i.e. the actuator unit, and the system being driven. The operating forces and torques acting on this interface, however, require a high mechanical strength of the coupling device. In addition, the decoupling action in the upper load range is either insufficient or too complicated to achieve and therefore tied to increased costs. Furthermore, it is not possible in every particular application to embody the connection with play or with a small contact surface, particularly when transmitting powerful operating forces and torques.

### ADVANTAGES OF THE INVENTION

The connecting device according to the present invention, with the defining characteristics of claim 1, has the advantage over the prior art that the connecting device for vibration decoupling purposes is placed between the motor housing and the transmission housing. This prevents the vibration generated by the motor from being transmitted into the transmission, thus from the outset preventing the vibrations of the motor from exciting vibrations in the transmission. In addition, the design according to present invention has the advantage that with the decoupling between the motor housing and the transmission housing, fewer operating forces and torques are transmitted via the connecting device than when the motor/transmission/drive unit is decoupled from an attached housing.

Advantageous modifications of the connecting device disclosed in claim 1 are possible by means of the steps taken in the dependent claims.

The connecting element is advantageously embodied as at least essentially rigid in a direction radial to the axis of the motor shaft. A particular cause for vibrations of the motor housing is the rotation of the motor at a particular rotation frequency. Since the connecting element is embodied so that it can be at least partially deformed in an elastic fashion when a rotating motion of the motor housing in relation to the transmission housing occurs around an axis established by the motor shaft, this at least essentially decouples the vibrations generated by the rotary motion of the motor. If the motor housing is tilted in relation to the ideal axis of the motor shaft, then an imbalance in the electric motor, a bending of the motor shaft, or the like can occur, which can cause vibrations to be generated. The embodiment of the connecting element as at least essentially rigid in the radial direction prevents the motor housing from tilting in relation to the transmission housing, thus remedying one cause for the generation of vibrations.

The connecting element is advantageously embodied as at least essentially elastically deformable in an axial direction relative to the axis of the motor shaft. The bearing already at least partially decouples the motor shaft from the motor housing in the axial direction. However, a wobble in the bearing of the electric motor and/or torque undulations of the electric motor can also generate axial vibrations of the motor housing. The capacity of the connecting element to elastically deform in the axial direction can also be used to effectively damp these vibrations.

It is advantageous that the connecting element is embodied so that the motor housing can be connected to the transmission housing, spaced axially apart from it. The motor housing resting against or striking against the transmission housing can cause considerable vibrations of the transmission housing when the electric motor vibrates. The above-mentioned embodiment can create a definite spacing between the transmission housing and the motor housing, thus preventing the generation and transmission of structure-borne noise.

It is possible to use the connecting element to connect the motor housing of an electric motor to the transmission housing and to connect the connecting element to the brush system component of the electric motor. The brush system components can be inserted into a housing part of the electric motor and can additionally be attached to it by means of a screw connection. The brush system component can be embodied in the form of a plastic part of the motor housing so that particularly with a plastic connecting element, the connection with the motor housing can be easily achieved, in particular by its being injection molded onto the motor housing.

It is also advantageous that the connecting element is embodied as U-shaped. In addition, it is advantageous for the connecting element to have a first and second leg that are connected to each other by a bridge piece. Depending on the elasticity of the bridge piece and the two legs, it is possible to selectively influence the elasticity values for a reciprocal pivoting of the two legs in the different spatial directions.

It is also advantageous that the connecting element can be connected to the motor housing in the region of an end surface of the first leg and can be connected to the transmission housing in the region of an end surface of the second leg. This type of connection makes it possible to individually predetermine the elasticity or rigidity and thus the damping action of the connecting element in the axial direction, radial direction, and rotation direction; it is also possible to selectively predetermine significantly different characteristic properties in the three directions mentioned.

Depending on the particular application, the connecting element can be at least partially comprised of an elastic plastic. The connecting element can also be made of a metal, particularly in the form of a spring piece. Alternatively or in addition, the connecting element can also be coated with a viscoelastic material.

### DRAWINGS

Exemplary embodiments of the present invention are shown in simplified fashion in the accompanying drawings and will be explained in greater detail in the description that follows.

FIG. 1 shows a first exemplary embodiment of a connecting device according to the present invention, which connects a motor housing to a transmission housing; and

FIG. 2 shows a connecting element of a connecting device according to the present invention in a second exemplary embodiment.

### DESCRIPTION OF THE EXEMPLARY EMBODIMENTS

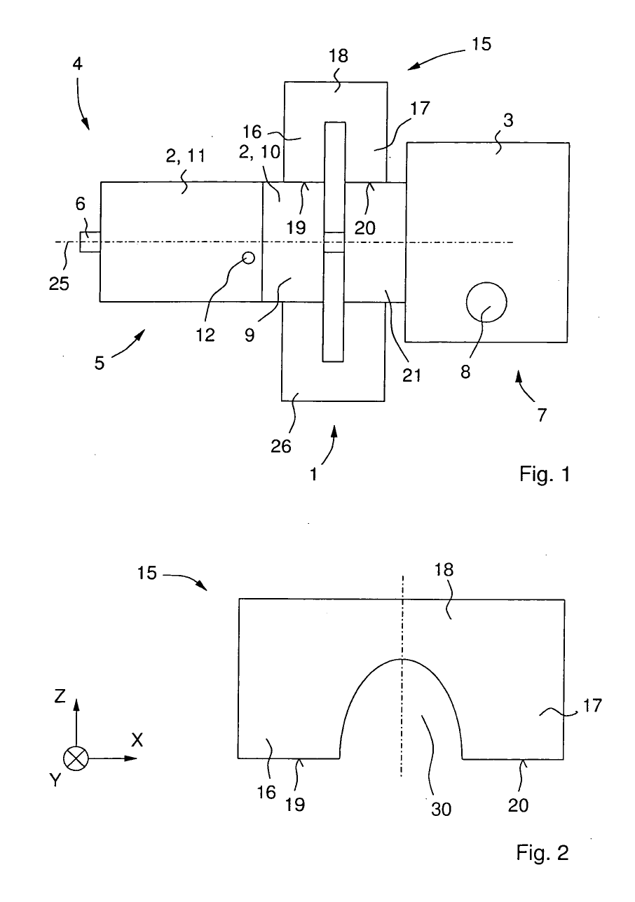

FIG. 1 is a schematic depiction of a connecting device 1 according to the present invention for mechanically connecting a motor housing 2 to a transmission housing 3. The connection produces a motor/transmission/drive unit 4 that is preferably used as an auxiliary drive unit, in particular an electric actuator unit used in motor vehicles for seat adjustment, powered movement of roof elements, windows, and the like. The connecting device 1 according to the present invention is also, however, suitable for other practical applications.

In the first exemplary embodiment shown in FIG. 1, the connecting device 1 connects the motor housing 2 of a motor 5 embodied in the form of an electric motor to the transmission housing 3. The motor 5 has a motor shaft 6 via which the motor 5 acts on a transmission 7 contained in the transmission housing 3. The operating forces and torques of the motor 5 are thus transmitted to the transmission 7 and converted by it. The converted operating forces and torques can be output at the power output 8 of the drive unit 4.

The motor 5 also has a brush system component 9, whose housing 10, together with a housing component 11 of the motor 5, constitutes the motor housing 2. The brush system component 9 is inserted into the housing part 11 of the motor 5 and is fastened to the housing part 11 by means of a screw connection at one or more fastening points 12.

The connecting device 1 has a connecting element 15 that is embodied as U-shaped. The connecting element 15 has a first leg 16, a second leg 17, and a bridge piece 18; the bridge piece 18 connects the first leg 16 to the second leg 17. In the region of a first end surface 19 of the first leg 16, the connecting element 15 is connected to the housing 10 of the brush system component 9 and consequently to the motor housing 2 of the motor 5. The housing 10 of the brush system component 9 is preferably comprised of plastic in order to facilitate the connection of the first leg 16 to the motor housing 2 in the region of the end surface 19. If at least the first leg 16 of the connecting element 15 is made of plastic, then the connecting element 15 can be injection molded onto the housing 10 of the brush system component 9 in the region of the end surface 19.

In addition, the connecting element 15 is attached to a housing part 21 of the transmission housing 3 in the region of an end surface 20 of the second leg 17. Like the housing 10 of the brush system component 9, the housing part 21 of the transmission housing 3 can also be made of plastic in order to facilitate the connection to the second leg 17 and in particular, to permit a second leg 17 made of plastic to be injection molded onto the housing part 21.

When the motor 5 is started, the motor shaft 6 is set into rotation, thus defining the axis 25 of the motor shaft 6 that coincides with the rotation axis of the motor 5.

In the first exemplary embodiment shown in FIG. 1, in addition to the connecting element 15, an additional connecting element 26 is provided, the two connecting elements being situated symmetrically relative to the axis 25 and offset from each other by 180°. To simplify depiction, two connecting elements 15, 26 are shown in the first exemplary embodiment. When the motor housing 2 is positioned in relation to the transmission housing 3 in accordance with the first exemplary embodiment, however, three connecting elements, which are situated symmetrically relative to the axis 25 and offset from one another by 120°, are required for a static, geometrically determined placement, making this a preferably selected embodiment. Another preferred embodiment is achieved with four connecting elements situated symmetrically relative to the axis 25 and offset from one another by 90°. The connecting device 1 can, however, also be equipped with one or more connecting elements 25, 26 in a different arrangement.

The connecting elements 15, 26 of the connecting device 1 are embodied so that they have the capacity to elastically deform with a rotation of the motor housing 2 around the axis 25 and in relation to the transmission housing 3. In this case, the first leg 16 and/or the second leg 17 can be embodied as flexible and the leg 18 can be embodied as rotatable. The connecting device 1 also creates an axial space between the transmission housing 3 and the motor housing 2. The connecting elements 15, 26 of the connecting device 1 can be embodied as rigid with regard to a movement of the motor housing 2 relative to the transmission housing 3 in an axial direction, i.e. in the direction of the axis 25, so that the axial spacing remains essentially constant. Preferably, however, the connecting device is also embodied as elastic in the axial direction so that the axial spacing between the motor housing 2 and the transmission housing 3 can change somewhat with the occurrence of vibrations. In addition, the connecting device 1 is embodied so that the axis 25 of the motor shaft 6 is held in its initial position. In particular, the connecting elements 15, 26 are embodied as rigid with regard to radial actuating forces of the motor housing 2 relative to the transmission housing 3.

The connecting device 1 selectively decouples vibrations emanating from the motor 5; the decoupling selectively occurs only in particular directions and in other directions, a rigid connection remains. To this end, the connecting elements 15, 26 of the connecting device 1 can be embodied in the form of resilient tabs that are rigid in two spatial directions and flexible in one spatial direction. This achieves a significantly lower vibration amplitude of the drive unit 4, thus reducing noise emissions due to airborne and especially structure-borne noise. In particular, the vibrations emanating from the motor side due to wobble, imbalance, or flexing of the motor shaft 6, torque undulations of the motor 5, and mechanical brush excitations of the brush system 9 are decoupled from the transmission side. On the transmission side, in particular, vibrations due to imbalance, flexing or wobble of the transmission shaft, tooth forces, gearing errors, out-of-roundness, torque undulations, and friction forces of the transmission 7 are decoupled from the motor side. In addition, the connecting device 1 prevents a direct transmission of structure-borne noise from the motor housing 2 to the transmission housing 3 and from the transmission housing 3 to the motor housing 2.

FIG. 2 shows a connecting element 15 of the connecting device 1 according to a second exemplary embodiment. Corresponding elements are provided with the same reference numerals. In addition, the following embodiments correspondingly also apply to the connecting elements 15, 26 of the exemplary embodiment of the connecting device 1 shown in FIG. 1.

The connecting element 15 is embodied as essentially rigid in a Z direction, i.e. when the first leg 16 is moved in the Z direction relative to the second leg 17, the connecting element 15 behaves in an essentially rigid fashion. When the first leg 16 is moved in an X direction relative to the second leg 17, the connecting element 15 likewise behaves in an essentially rigid fashion. Preferably, however, it can also behave in a slightly elastic fashion in the X direction. The connecting element 15 is also embodied so that when the first leg 16 is moved in a Y direction in relation to the second leg 17, the bridge piece 18 bends in an elastic fashion. It is also possible for the first leg 16 and/or second leg 17 to bend partially. The connecting element 15 is thin, i.e. the dimension in the Y direction is small in comparison to the dimensions in the X direction and Z direction.

When the connecting device 1 is in the installed position, in which the motor housing 2 is connected to the transmission housing 3 by means of the connecting device 1, the X direction is oriented parallel to the axis 25, the Z direction points in a radial direction relative to the axis 25, and the Y direction is perpendicular to the X direction and Z direction. The Y direction therefore points in a circumference direction relative to the axis 25.

The connecting element 15 has a recess 30. In the region of the recess 30, the connecting element 15 is concave, i.e. has the shape of a magnifying mirror. The recess 30 here is embodied in an at least approximately ellipsoidal form. In particular, the shape of the recess 30 can be determined by a finite element calculation in order to achieve a uniform distribution of force, particularly in the region of the bridge piece 18. It is possible to use the shape of the bridge piece 18 to predetermine the desired damping properties, particularly with regard to the decoupling frequency range. Generally, the decoupling action and the decoupling frequency range of the connecting device 1 can be established through the geometry and/or the selection of one or more materials of the connecting element 15; the rigidity in the X, Y, and Z directions can be predetermined in various ways in order to suitably decouple the housing 2, 3 with regard to various noise and/or force transmissions in the different spatial directions X, Y, and Z.

Conceivable materials for the decoupling element include rubber elements of the kind normally used for noise reduction. It would also be conceivable to use metal spring elements. Preferably, the elements are injection molded out of plastic and embodied in the form of a spring piece. In particular, these spring pieces can be integrally molded onto the housing part 21 of the transmission housing 3 and/or onto the housing 10 of the brush system component 9 or the transmission housing 3.

The connecting device 1 can also occur in combination with a decoupling or separation of the motor shaft 6 from the associated shaft (not shown) of the transmission housing 3. This can be achieved, for example, by means of a bellows coupling or an elastomer coupling.

Thermoplastic plastics and particularly also polyamide can be used to manufacture the connecting element 15. To connect the connecting elements 15, 26 to the motor housing 2 and/or the transmission housing 3, it is also possible for a recess to be provided in the motor housing 2 and/or transmission housing 3, in the region of the end surfaces 19, 20 of the connecting element 15 and/or the corresponding surfaces of the connecting element 26.

The present invention is not limited to the exemplary embodiments described herein.

What is claimed is:

1. A connecting device (1) for mechanically connecting a motor housing (2) of a motor (5) to a transmission housing (3) of a transmission (7), in which the motor (5) acts on the transmission (7) via a motor shaft (6), wherein at least one connecting element (15, 26) is provided, which is capable of connecting the motor housing (2) indirectly to the transmission housing (3), and the connecting element (15, 26) is embodied so that when the motor housing (2) moves relative to the transmission housing (3) in a rotating fashion around an axis (25) predetermined by the motor shaft (6), the connecting element (15, 26) is able to be at least partially deformed in an elastic fashion.

2. The connecting device as recited in claim 1, wherein the connecting element (15, 26) is embodied as at least essentially rigid in a direction (Z) radial to the axis (25) of the motor shaft (6).

3. The connecting device as recited in claim 1, wherein the connecting element (15, 26) is embodied as at least essentially elastically deformable in a direction (X) axial to the axis (25) of the motor shaft (6).

4. The connecting device as recited in claim 1, wherein the connecting element (15, 26) is embodied so that it is possible to connect the motor housing (2) to the transmission housing (3), spaced axially apart from it.

5. The connecting device as recited in claim 1, wherein the connecting element (15, 26) is embodied as U-shaped.

6. The connecting device as recited in claim 5, wherein the connecting element (15, 26) has a first leg (16) and second leg (17) that are connected to each other by a bridge piece (18).

7. The connecting device as recited in claim 6, wherein it is possible to connect the connecting element (15, 26) to the motor housing (2) in the region of an end surface (19) of the first leg (16).

8. The connecting device as recited in claim 6, wherein it is possible to connect the connecting element (15, 26) to the transmission housing (3) in the region of an end surface (20) of the second leg (17).

9. The connecting device as recited in claim 6, wherein the connecting element (15, 26) has a recess (30) and in the region of the recess (30), the connecting element (15, 26) is embodied as at least essentially concave.

10. The connecting device as recited in claim 9, wherein the recess (30) is partially embodied in an approximately ellipsoidal form.

11. The connecting device as recited in claim 1, wherein the connecting element (15, 26) is at least partially comprised of an elastic plastic.

12. The connecting device as recited in claim 1, wherein the connecting element (15, 26) is at least partially coated with a viscoelastic material.

13. The connecting device as recited in claim 1,
wherein relative to its axial dimension (X) and its radial dimension (Z), the connecting element (15, 26) is embodied as thin in a predetermined circumference direction (Y) in relation to the rotation direction of the motor shaft (6).
